(19) United States
(12) Patent Application Publication
(10) Pub. No.: US 2012/0018386 A1
(43) Pub. Date: Jan. 26, 2012

(54) Deepwater oil recovery process

(76) Inventors: Dennis McGuire, Stuart, FL (US); Sanjeev Jakhete, Stuart, FL (US)

(21) Appl. No.: 13/157,143

(22) Filed: Jun. 9, 2011

Related U.S. Application Data
(63) Continuation-in-part of application No. 13/019,113, filed on Feb. 1, 2011.
Application No. 13/019,113 is a continuation-in-part of application No. 12/765,971, filed on Apr. 23, 2010.
Application No. 12/765,971 is a continuation-in-part of application No. 12/399,481, filed on Mar. 6, 2009, now Pat. No. 7,699,988.
Application No. 12/399,481 is a continuation-in-part of application No. 12/184,716, filed on Aug. 1, 2008, now Pat. No. 7,699,994.
(60) Provisional application No. 61/353,041, filed on Jun. 9, 2010.
(60) Provisional application No. 61/495,237, filed on Jun. 9, 2011.
(60) Provisional application No. 60/953,584, filed on Aug. 2, 2007.

(51) Int. Cl. C02F 1/40; C02F 9/00; C02F 1/78; C02F 1/24; C02F 1/36

(52) U.S. Cl. 210/706; 210/150

(57) ABSTRACT

Ozone/oxygen gas is mixed with treated seawater at 30% quality foam and injected to the wellhead at the sea floor. At the seafloor, a tank mixing eductor would be used to mix high pressure oxygen bubbles with the oil contaminated seawater by shearing the oil globs into small oil droplets allowing the new surface area to immediately react with the dissolved ozone/oxygen in the seawater. The ozone/oxygen admixture creating an attraction force between the droplets and the oxygen bubbles. As the droplets and bubble rise, they form larger spherical top-hat bubbles that rise faster in the seawater. In the preferred embodiment, the eductor employs a cone shape flow to direct a significant amount of the oil plume into a predictable area that can then be skimmed mechanically for harvesting or destruction.

### CROSS-REFERENCE TO RELATED APPLICATIONS

The instant application claims the priority date of U.S. Provisional Patent Application 61/353,041 filed Jun. 9, 2010 the contents of which are incorporated herein by reference. This application is related to U.S. patent application entitled “Apparatus for Treating Fluids”, filed as provisional No. 61/495,237 on Jun. 9, 2011 which is a continuation-in-part of U.S. patent application Ser. No. 13/019,113, entitled “Transportable Reactor Tank”, filed Feb. 1, 2011, which is a continuation-in-part of U.S. patent application Ser. No. 12/765,971, entitled “Improved Reactor Tank”, filed Apr. 23, 2010, which is a continuation-in-part of U.S. patent application Ser. No. 12/399,481, entitled “Enhanced Water Treatment for Reclamation of Waste Fluids and Increased Efficiency Treatment of Potable Waters”, filed Mar. 6, 2009, now U.S. Pat. No. 7,699,988, issued Apr. 20, 2010, which is a continuation-in-part of U.S. patent application Ser. No. 12/184,716, entitled “Enhanced Water Treatment for Reclamation of Waste Fluids and Increased Efficiency Treatment of Potable Waters”, filed Aug. 1, 2008, now U.S. Pat. No. 7,699,994, issued Apr. 20, 2010, which in turn is a continuation-in-part of U.S. Provisional Patent Application No. 60/953,584, entitled “Enhanced Water Treatment for Reclamation of Waste Fluids and Increased Efficiency Treatment of Potable Water”, filed Aug. 2, 2007, the contents of which are hereby expressly incorporated by reference.

### FIELD OF THE INVENTION

This invention is directed to the field of oil recovery and in particular to a deepwater oil recovery process.

### BACKGROUND OF THE INVENTION

On Apr. 20, 2010, a semi-submersible exploratory offshore drilling rig in the Gulf of Mexico exploded resulting in an oil spill described as the largest environmental disaster in U.S. history. Due to the location of the oil leak, nearly one mile beneath the surface of the water, accurate predictions of the volume of oil released is not possible. While the owners of the drilling rig estimate that an oil leak between 1,000 and 5,000 barrels a day is occurring, scientists have estimated oil flow rates up to 84,000 barrels per day (13,400 m3/d). A second, smaller leak has been estimated to be releasing 25,000 barrels per day (4,000 m3/d) by itself suggesting that the total size of the leak may well be in excess of 100,000 barrels per day.

No matter what the actual amount of oil has leaked, an oil spill can contaminate the coast lines and threatens wildlife refuges, ecologically sensitive areas, fisheries, as well as densely populated waterfronts. Efforts to address oil spills include controlled burns which have limited success and pose yet another ecological problem. Inflatable booms have been deployed wherein floating oil is contained and skimmers are then used to draw oil from the surface. However, the oil disperses very quickly making containment difficult, even when the seas are calm.

To combat the oil spill huge quantities of chemical dispersant are being deployed in an effort to stop the oil reaching land. Oil dispersants are detergent-like chemicals that break up oil slicks on the surface of the water into smaller droplets, with the belief that the smaller amounts can then be broken down by water born bacteria and other natural processes. Dispersants can help prevent the oil droplets from coalescing to form other slicks. However, oil spill dispersants do not reduce the total amount of oil entering the environment. Rather, they change the chemical and physical properties of the oil, making it more likely to mix into the water column and hopefully the admixture will not further contaminate the shoreline. Dispersants alter the destination of the toxic compounds in the oil, redirecting its impact from feathered and fur-bearing animals on shore to organisms in the water column itself and on the seafloor. Most critically, a large quantity of the dispersant is being injected into the oil leak at the ocean bottom, some 5000 feet deep. The result is the suppressing of a large amount of oil from every reaching the surface of the water.

The current deployment of dispersants will likely result in the single largest deployment of dispersants against an oil spill in U.S. history as reports indicated that nearly 140,000 gallons (529,928 liters) of dispersants have been used within the first 50 days of the oil spill.

Corexit® and other dispersants, made up of classified chemicals may result in a devastating effect in the Gulf. Aside from the fact that dispersants never before have been used on such a vast scale, the current chemicals are being injection at the well head over 5000 feet deep which has never occurred before. In addition, the dispersants are made up of a classified chemical so it is not possible to access the danger they pose when the ingredients are kept confidential.

### SUMMARY OF THE INVENTION

The instant invention is a method of treating deep water oil spills by use of an ozone/oxygen gas (8%/92%) that is mixed with treated seawater at 30% quality foam and fed into the charge pump to inject the foam into the transfer line leading to the wellhead at the sea floor, adjacent the oil leak. At the seafloor, a tank mixing eductor such as a 6 inch Lobestar from vortex Ventures, would be used to mix high pressure oxygen bubbles with the oil contaminated seawater. The Lobestar will shear the oil globs to small oil droplets. This huge new surface area will immediately react with the dissolved ozone/oxygen in the seawater, which then will cause an attraction force between the droplets and the oxygen bubbles. As the droplets and bubble rise, they will want to make larger spherical hat bubbles that rise even faster in the seawater.

The eductor will employ a cone to direct a significant amount of the oil plume into the intake. The missed oil plume will tend to follow the oxygen gas plume to the surface because it is moving faster than the local seawater. This is a similar principle to that of free jet NATCO dissolved gas floatation unit for produced brine treatment, except the Gulf of Mexico has no walls and is a lot deeper.

Calculations can be made as to how much addition oxygen gas will be needed for the brine/ozone bubble mixture to handle the estimated oil rate at the sea floor. It is estimated that 150% oxygen gas volume is needed with an oil volume at seafloor pressure of 2270 psi.

An objective of the instant invention is to protect the environment by providing a method of controlling an oil spill from the underwater location.

Still another objective of the invention is to teach the use of a two step remediation process comprising a first stage of raising spilled oil with millions of tiny ozone/oxygen bubbles while the ozone breaks down heavy components in the oil; and a second stage of producing two separate flows containing concentrated oil product and clean highly oxygenated seawater. The oily residue in the seawater will pass through a reactor where it will be oxidized to carbon dioxide. The treated seawater can then be discharged with ozone bubbles to provide dissolved gas floatation of the oil slick.

Another objective of the invention is to provide an apparatus and method to converts asphaltenes to lower molecular weight compounds and coke;

Still another objective of the invention is to provide an apparatus and method that reacts directly with double bonds in petroleum compounds.

Yet still another objective of the invention is to provide an apparatus and method capable of providing an optimum oxidation ratio of 0.9 mg Ozone to 1 mg of mixed hydrocarbon.

Another objective of the invention is to provide an apparatus and method capable of providing an optimum oxidation ratio of 0.9 mg Ozone to 1 mg of mixed hydrocarbon.

Yet still another objective of the invention is to provide an apparatus and method capable of making crude oil more bio-degradable.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a cross sectional view of a Cavitational Reactor of the instant invention;

FIG. 2 is a flow diagram of the instant invention;

FIG. 3A is a side view of a flash reactor;

FIG. 3B is a perspective view of one the flash reactor;

FIG. 3C is a sectional view of the flash reactor taken along line A-A of FIG. 3A;

FIG. 4 is a prespective view of a cavitation plate;

FIG. 5 is an end view of a cavitation plate; and

FIG. 6 is an enlarged view of a cavitation hole.

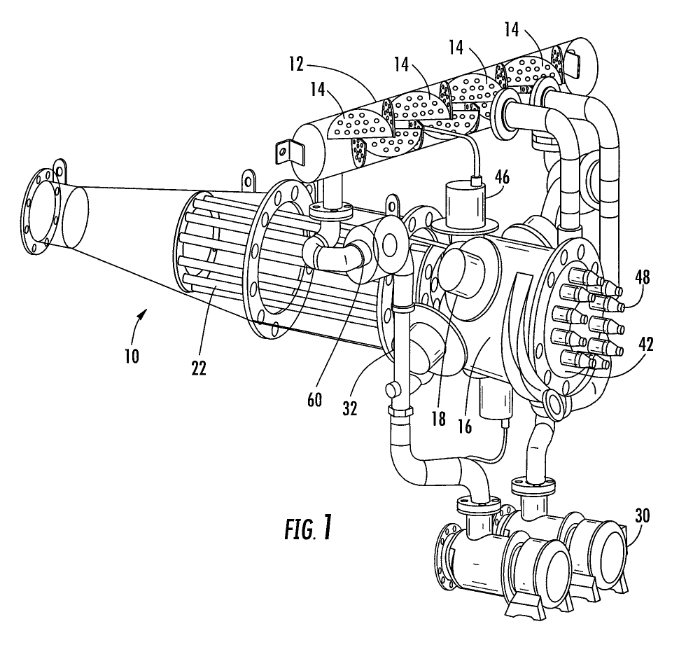

### DETAILED DESCRIPTION OF THE INVENTION

For use by example, the previously mentioned situation consists of an oil plume having about a 3000 GOR with the oil venting into seawater at about 2270 psi and 33 F. Methane rich gas forms gas hydrates in this environment at a specific gravity of 0.9. The degassed oil plume has density close to about 0.8 specific gravity and close to about 120 cp viscosity. The addition of a dispersant causes significant (about 4 to 1) emulsification of seawater and oil. It should be noted that to bio-degrade 10,000 bbls of oil by weathering would require approximately 40 square miles of seawater above the thermocline. Thermochimica Acta Volume 312, Issue 1-2, Mar. 23, 1998, Pages 87-93, shows that the heat of adsorption for oxygen gas is 125 kcal/gmol for the unsaturated carbon sites. This is an exothermic reaction, not oxidation. It is adsorption of an oxygen molecule on an unsaturated site in the asphaltene molecule which is similar to hydrogen bonding of sticky maple syrup on a plate surface. Due to the large number of double bonds in an asphaltene molecule, the oil/water interface of the droplet will exhibit similarity to oxygen gas after oxygen molecule absorption, therefore the remaining ozone/oxygen gas in the bubble will want to ‘stick’ or be attracted to the oxygenate asphaltene interface of the oil droplet.

SeaWorld and other water parks experience have shown that 200 ppm ozone concentration in the stripping gas provides enough gas interface charge to ‘protein skim’ fish oil/tanning oil from the seawater aquarium or water park exhibits. The 8% ozone will provide a safety factor for oil droplet ride to the surface of the water as the double bonds in the crude oil react with the ozone. This oxygen adsorption is a first big step in aerobic digestion by local bacteria or weathering of the crude oil in nature.

Referring now to the figures, set forth is a Cavitational Reactor 10 having a hydrodynamic cavitation zone 12 where primary oxidation reaction takes place. Mixing plates 14 with sharp laser edge holes create hydrodynamic cavitation. A hydrodynamic cavitation zone is formed within a manifold constructed with static mixer vanes 14 to encourage the homogeneous mixing of the fluid before entering the main reactor. Holes 15 formed within the mixing vanes 14 act as orifices and allow varying pressure at multiple locations. The holes 15 in each of the baffles 18 act as localized orifices, dropping the pressure of the fluid locally allowing the formation of cavitation bubbles. As these cavitation bubbles are carried away with the flow, these bubbles collapse or implode in the zone of higher pressure. The collapse of the cavitation bubbles at multiple locations within the system produces localized high energy conditions such as shear, high pressure, heat light, mechanical vibration, etc. These localized high energy conditions facilitate the breakdown of organic substances. The baffles are arranged so that when the fluid is discharged from one baffle, it discharges with a swirling action and then strikes the downstream baffle. The baffles provide a local contraction of the flow as the fluid flow confronts the baffle element thus increasing the fluid flow pressure. As the fluid flow passes the baffle, the fluid flow enters a zone of decreased pressure downstream of the baffle element thereby creating a hydrodynamic cavitation field. Hydrodynamic cavitation typically takes place by the flow of a liquid under controlled conditions through various geometries. The phenomenon consists in the formation of hollow spaces which are filled with a vapor gas mixture in the interior of a fast flowing liquid or at peripheral regions of a fixed body which is difficult for the fluid to flow around and the result is a local pressure drop caused by the liquid movement. At a particular velocity the pressure may fall below the vapor pressure of the liquid being pumped, thus causing partial vaporization of the cavitating fluid. With the reduction of pressure there is liberation of the gases which are dissolved in the cavitating liquid. These gas bubbles also oscillate and then give rise to the pressure and temperature pulses. The mixing action is based on a large number of forces originating from the collapsing or implosions of cavitation bubbles. If during the process of movement of the fluid the pressure at some point decreases to a magnitude under which the fluid reaches a boiling point for this pressure, then a great number of vapor filled cavities and bubbles are formed. Insofar as the vapor filled bubbles and cavities move together with the fluid flow, these bubbles move into an elevated pressure zone. Where these bubbles and cavities enter a zone having increased pressure, vapor condensation takes place within the cavities and bubbles, almost instantaneously, causing the cavities and bubbles to collapse, creating very large pressure impulses. The magnitude of the pressure impulses with the collapsing cavities and bubbles may reach ultra high pressure implosions leading to the formation of shock waves that emanate from the point of each collapsed bubble.

The holes 15 located on each of the baffles 17 form diverging nozzles 90 having an inlet aperture 92 on the upstream side having a diameter that is smaller than the diameter of the outlet aperture 94 on the downstream side of the blade. The inlet aperture and outlet aperture are connected by a conically shaped hole 15. The mixers use the energy of the flow stream to create mixing between fluids with the lowest possible pressure loss. The hydrodynamic cavitation mixing manifold can receive a single input or multiple inputs as depicted by seawater pump 30 and flash reactor 38.

An acoustic cavitation zone 16 is created by the use of dual frequency ultrasonic transducers 18 where the ozone mass transfer efficiency is enhanced. In this embodiment, billions of bubbles approximately 1 mm are created. An electrochemical decomposition zone 20 is formed by use of platinum electrodes 22 which is a secondary oxidation reaction to generate hydroxyl radicals using oxygen molecules and using hydrogen by splitting water the molecules. The OH— hydroxyl radicals oxidize left over organics and complete the oxidation reaction. Another by product created during this electro oxidation process is hydrogen peroxide and sodium hypo chloride which also aids in the oxidation process.

The bubbles provide surface area for the oil to adhere to rising up to the surface of the ocean in the enriched column of air. Once the oil is on the surface of the water, the oil can be encircled with a boom to allow for efficiency in skimming.

Referring to FIG. 2, set forth is a flow diagram of the method of operation. The method of treating deep water oil leaks comprises at least one pump 30 that draws water from the ocean for conditioning. The pump 30 is capable of pressurized pumping and is sized in accordance with the capacity of the oil leak. The pump transfers seawater for conditioning by first injecting a combination of ozone and oxygen into the seawater being pumped by an injector 32 fed by an ozone generator 34. The ozone generator 34 is further fed by an oxygen generator 36, the mixture of which can be regulated through the ozone generator. In the preferred embodiment the ozone/oxygen ration is about 8% ozone and 92% oxygen. Injection of ozone is preferably by a venturi type mixing device such as a Mazzie® injector. The output of the ozone generator is automatically metered using a PID control loop.

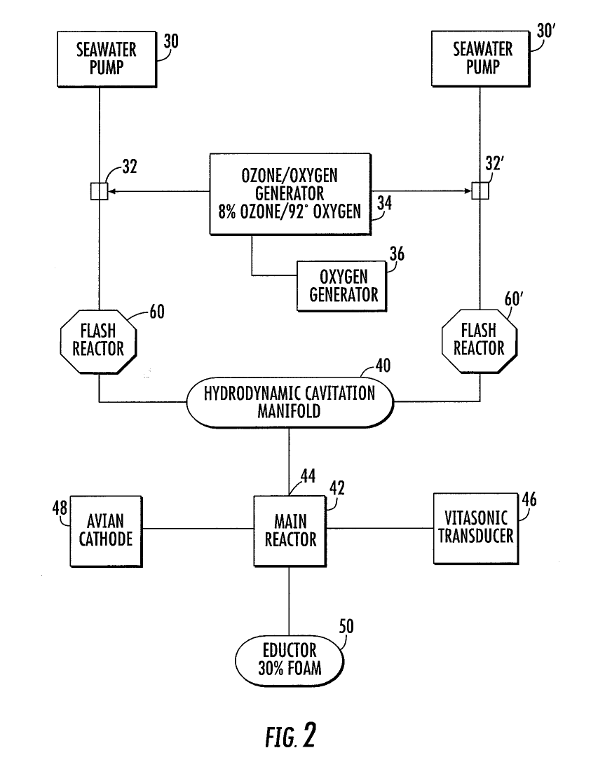

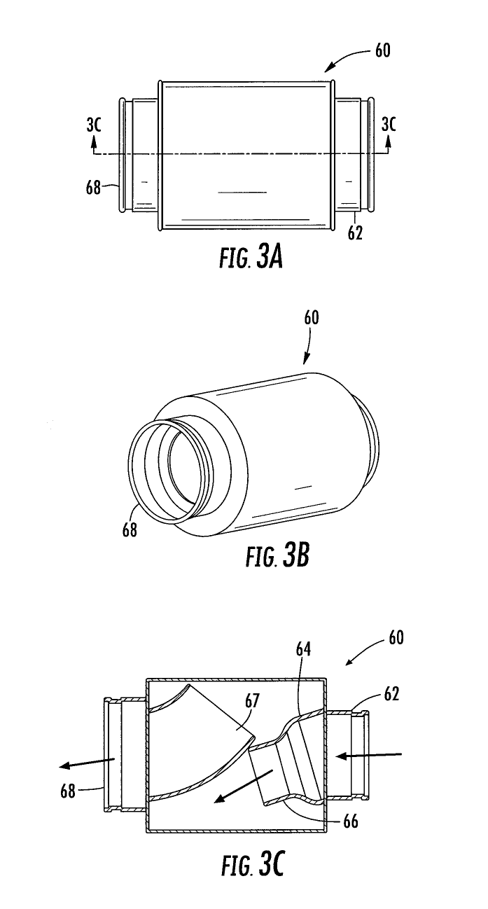

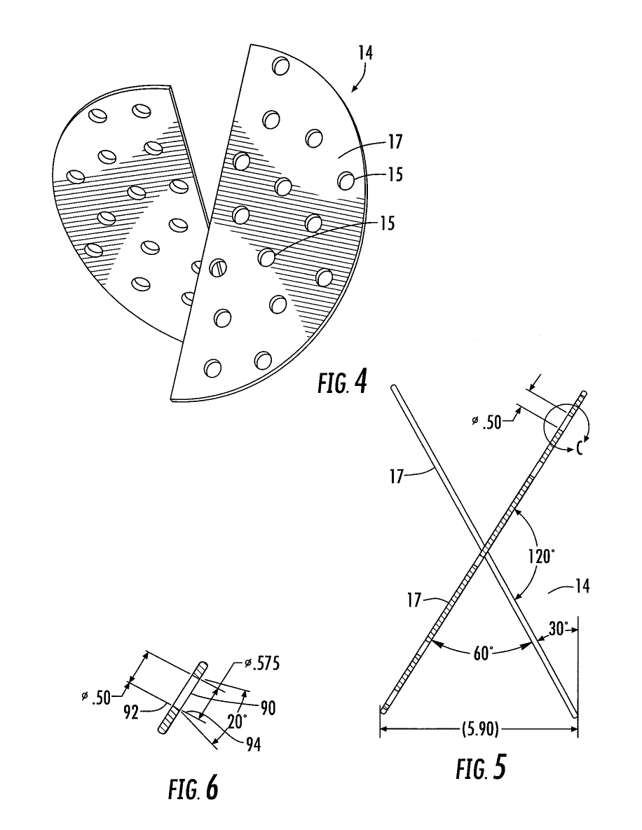

The ozone/oxygen is mixed with the seawater by directing the mixture through a flash reactor 60 having flow paths creating areas of severe velocity and pressure changes which are constructed and arranged to reduce the size of ozone bubbles into nano-sized bubbles. FIG. 3A is a side view of a one of the flash reactors, FIG. 3B is a perspective view of one of the flash reactors and FIG. 3C is a sectional view of one of the flash reactors taken along line A-A of FIG. 3A. Flash reactor 60 is formed as a generally cylindrical housing and has inlet conduit 62 that is smaller in diameter than outlet conduit 68. Within the flash reactor housing 60 the inlet conduit 62 is fluidly connected to a slightly curved section of conduit 64 having a reduced portion 66. Also within the flash reactor 60 is a curved section of conduit 67 that is fluidly connected to outlet conduit 68. The direction of curvature of conduit section 64 is opposite to that of curved conduit 67. As the flow of fluid that has been mixed with ozone is passed through the flash reactor 60 the sizes of gas bubbles are reduced to nano size by high shear. The uni-directional and shearing design of the gas/liquid water mixture allows for a rapid dissolution and attainment of gas/liquid equilibrium which results in high mass transfer efficiency with a minimal time. Due to the configuration of the flow paths within the flash reactor 60 there are different areas within the flash reactor where severe velocity and pressure changes take place. These drastic velocity and pressure changes create high shear which reduces the size of the ozone/oxygen bubbles to nano size and also dissolving more gas into the fluid which is under pressure.

The admixed ozonated seawater is directed through a main reactor 42 by use of a converging dynamic nozzle 44 capable of inducing cavitation. The main reactor includes a plurality of ultrasonic transducers assemblies 46 for generating acoustic cavitation of the admixed ozonated seawater. The ultrasonic transducers located around the periphery of the main reactor emit ultrasonic waves in the range of 16 KHz and 20 KHz into the flow of water. A sonoluminescence effect is observed due to acoustic cavitation as these ultrasonic waves propagate in the water and catch the micro bubbles in the valley of the wave. Sonoluminescence occurs whenever a sound wave of sufficient intensity induces a gaseous cavity within a liquid to quickly collapse. This cavity may take the form of a pre-existing bubble, or may be generated through hydrodynamic and acoustic cavitation. Sonoluminescence can be made to be stable, so that a single bubble will expand and collapse over and over again in a periodic fashion, emitting a burst of light each time it collapses. The frequencies of resonance depend on the shape and size of the container in which the bubble is contained. The light flashes from the bubbles are extremely short, between 35 and few hundred picoseconds long, with peak intensities of the order of 1-10 mW. The bubbles are very small when they emit light, about 1 micrometer in diameter depending on the ambient fluid, such as water, and the gas content of the bubble. Single bubble sonoluminescence pulses can have very stable periods and positions. In fact, the frequency of light flashes can be more stable than the rated frequency stability of the oscillator making the sound waves driving them. However, the stability analysis of the bubble shows that the bubble itself undergoes significant geometric instabilities, due to, for example, the Bjerknes forces and the Rayleigh-Taylor instabilities. The wavelength of emitted light is very short; the spectrum can reach into the ultraviolet. Light of shorter wavelength has higher energy, and the measured spectrum of emitted light seems to indicate a temperature in the bubble of at least 20,000 Kelvin, up to a possible temperature in excess of one mega Kelvin. The veracity of these estimates is hindered by the fact that water, for example, absorbs nearly all wavelengths below 200 nm. This has led to differing estimates on the temperature in the bubble, since they are extrapolated from the emission spectra taken during collapse, or estimated using a modified Rayleigh-Plesset equation. During bubble collapse, the inertia of the surrounding water causes high speed and high pressure, reaching around 10,000 K in the interior of the bubble, causing ionization of a small fraction of the noble gas present. The amount ionized is small enough fir the bubble to remain transparent, allowing volume emission; surface emission would produce more intense light of longer duration, dependent on wavelength, contradicting experimental results. Electrons from ionized atoms interact mainly with neutral atoms causing thermal bremsstrahlung radiation. As the ultrasonic waves hit a low energy trough, the pressure drops, allowing electrons to recombine with atoms, and light emission to cease due to this lack of free electrons. This makes for a 160 picosecond light pulse for argon, as even a small drop in temperature causes a large drop in ionization, due to the large ionization energy relative to the photon energy.

The main reactor 42 can further include a plurality of disc anodes located about the circumference of the main reactor. In addition, there are two groups of anode electrodes that may extend longitudinally into the main reactor from the end plates of the main reactor. The preferred density is maintained between 0.6 Amps/inz to 1.875 Amps/inz during the process with the turbulent flow through the main reactor to aid in efficient electrons migration between the anodes. These electrodes are non active electrodes where the anode material acts as a catalyst and the oxidation is assisted by hydroxyl radicals that are generated at the electrode surface. During electro-chemical oxygen transfer reaction Hydroxyl radicals are generated. The platinum electrode which is electro catalytic produces hydroxyl radicals by dissociative adsorption of water followed by hydrogen discharge. In the process the electric potential is maintained higher than 1.23V (which is higher than thermodynamic potential of water decomposition in acidic medium) the water discharge occurs, leading to the formation of hydroxyl radicals. The production of oxidants can be performed either by a fast and direct reaction involving one electron transfer or by an indirect mechanism assisted by electro generated intermediates (hydroxyl radicals), cathode anodes may be used to further the potential differential.

The pressured fluid is then delivered to the oil leak by use of an eductor 50 placed adjacent to the oil leak, the eductor 50 inserting the admixed ozonated seawater having nano-sized bubbles subjected to acoustic and hydrodynamic cavitation is expelled from said eductor for shearing oil globs from the oil leak into oil droplets. The force of the leak drawing suction to assist in expelling the admixture from the pressurized source. The oil droplets reacting with the admixed ozonated seawater causing an attraction force therebetween allowing the oil droplets to rise into larger spherical top-hat bubbles transporting the oil to the surface of the water, whereby said oil can be removed by conventional non-chemical separation. In the preferred embodiment, the educator is used to disperse in a cone shape allowing for directional control of the oil as it rises to the surface. In very deep water applications, a charge pump and triplex pump may be used to overcome pressurization differential, especially if the oil leak is of low volume and provides insufficient pressure to allow effective use of the eductor. The eductor, placed at the seafloor within the leak, is a tank mixing eductor such as a 6 inch Lobestar from Vortex Ventures capable of mixing high pressure oxygen bubbles with the oil contaminated seawater. The admixed seawater is about 30% quality bubbles at 125 psi.

It is to be understood that while we have illustrated and described certain forms of my invention, it is not to be limited to the specific forms or arrangement of parts herein described and shown. It will be apparent to those skilled in the art that various changes may be made without departing from the scope of the invention and the invention is not to be considered limited to what is shown in the drawings and described in the specification.

What is claimed is:

1. A system for treating deep water oil leaks comprising:
a pump having an inlet and an outlet, said pump inlet being fluidly connected to a seawater source;
an ozone injection device having an inlet and an outlet, said inlet of said fluid communication said outlet of said pump, whereby ozone is injected into the seawater fluid;
a flash reactor in fluid communication having an inlet and an outlet, said inlet of said flash reactor in fluid communication with said outlet of said ozone injection device, said flash reactor having flow paths creating areas of severe velocity and pressure changes constructed and arrange to reduce the size of ozone bubbles created by said ozone injection device into nano-sized bubbles;
a hydrodynamic cavitation mixing manifold having an inlet and an outlet, said inlet of said hydrodynamic cavitation mixing manifold in fluid communication with said outlet of the flash reactor for admixing said ozone and seawater;
a converging dynamic nozzle having an inlet and an outlet, said inlet fluidly coupled to said outlet of said hydrodynamic mixing manifold;
a main reactor having an inlet and an outlet, said main reactor fluidly coupled to said outlet of said hydrodynamic mixing manifold, said main reactor including a plurality of ultrasonic transducers assemblies for generating acoustic cavitation of said admixed seawater;
a tank mixing eductor fluidly coupled to said outlet of said main reactor said eductor juxtapositioned to a deep water oil leak;
wherein said admixed ozonated seawater having nano-sized bubbles subjected to acoustic and hydrodynamic cavitation is expelled from said eductor for shearing oil globs from the oil leak into oil droplets, said oil droplets reacting with the admixed ozonated seawater causing an attraction force therebetween allowing the oil droplets to rise into larger spherical hat bubbles transporting the oil to the surface of the water, whereby said oil can be removed by conventional non-chemical separation.

2. The system for treating deep water oil leaks according to claim 1 wherein said eductor is constructed and arranged to disperse in a cone shape for directional control of said oil.

3. The system for treating deep water oil leaks according to claim 1 wherein said main reactor includes a plurality of anodes and cathodes to create an electrical potential.

4. The system for treating deep water oil leaks according to claim 1 including an oxygen generator that produces oxygen that is fed to an ozone generator that is fed to said ozone injection device.

5. The system for treating deep water oil leaks according to claim 1 wherein said ozone injection device is a high efficiency, venturi type, differential pressure injector.

6. A method of treating deep water oil leaks comprising:
pumping seawater for conditioning;
inserting a mixture of ozone and oxygen into the seawater being pumped;
directing said ozonated seawater through a flash reactor having flow paths creating areas of severe velocity and pressure changes constructed and arranged to reduce the size of ozone bubbles created by said ozone injection device into nano-sized bubbles;
admixing said ozonated seawater with a hydrodynamic cavitation mixing manifold having static shearing baffles contained therein;
inducing said admixed ozonated seawater in a main reactor by use of a converging dynamic nozzle having to induce cavitation, said main reactor including a plurality of ultrasonic transducers assemblies for generating acoustic cavitation of said admixed ozonated seawater;
educting said admixed ozonated seawater into the oil leak;
wherein said admixed ozonated seawater having nano-sized bubbles subjected to acoustic and hydrodynamic cavitation is expelled from said eductor for shearing oil globs from the oil leak into oil droplets, said oil droplets reacting with the admixed ozonated seawater causing an attraction force therebetween allowing the oil droplets to rise into larger spherical hat bubbles transporting the oil to the surface of the water, whereby said oil can be removed by conventional non-chemical separation.

7. The method for treating deep water oil leaks according to claim 6 including the step of shaping said eductor to disperse in a cone shape for directional control of said oil.

8. The method for treating deep water oil leaks according to claim 6 including the step of subjecting said admixed seawater to create an electrical potential by use of a plurality of anodes and cathodes mounted in said main reactor.

9. The method for treating deep water oil leaks according to claim 1 wherein said ozone is formed by an ozone generator that is fed oxygen from an oxygen generator

10. The method for treating deep water oil leaks according to claim 1 wherein said ozone that is injection is about 8% ozone and 92% oxygen.

11. The method for treating deep water oil leaks according to claim 1 wherein said admixed seawater is about 30% foam.
